(19) United States
(12) Patent Application Publication
(10) Pub. No.: US 2025/0210018 A1
(43) Pub. Date: Jun. 26, 2025

(54) KEYBOARD DEVICE AND METHOD FOR DETECTING KEY-PRESSING INFORMATION

(71) Applicant: Roland Corporation, Shizuoka (JP)

(72) Inventors: Yukihide Takata, Shizuoka (JP); Mutsuo Sawada, Shizuoka (JP); Shiro Uno, Shizuoka (JP)

(73) Assignee: Roland Corporation, Shizuoka (JP)

(21) Appl. No.: 18/977,919

(22) Filed: Dec. 12, 2024

(30) Foreign Application Priority Data
Dec. 26, 2023 (JP) 2023-220034

(51) Int. Cl. G10H 1/055; G10H 1/34

(52) U.S. Cl. CPC G10H 1/0555; G10H 1/344

(57) ABSTRACT

Since the curvature of a plane part 82b is smaller than that of a curved surface part 82a, it is possible for the distance between a coil 100 and the detected part 82 (plane part 82b) to be short in the aftertouch performance region than the case where the detected part 82 is one arc shape centered on a rotation shaft 90. Accordingly, the dynamic range can expand (with a significantly decrease in the sensor output value in the aftertouch performance region) without enlarging the displacement member 8 (coil 100). Accordingly, aftertouch can be accurately detected while the displacement member 8 can be miniaturized.

### CROSS-REFERENCE TO RELATED APPLICATION

This application claims the priority benefit of Japan application serial no. 2023-220034, filed on Dec. 26, 2023. The entirety of the above-mentioned patent application is hereby incorporated by reference herein and made a part of this specification.

### BACKGROUND

### Technical Field

The invention relates to a keyboard device and a method for detecting key-pressing information, and particularly to a keyboard device and a method for detecting key-pressing information that can accurately detect key-pressing information while miniaturizing a displacement member.

### Description of Related Art

A technique for detecting the depth and the velocity of pressing a key (hereinafter referred to as “key-pressing information”) by using a contactless sensor is known. For example, Patent Document 1 discloses a technique in which a coil 57 (sensor) generating a magnetic field is formed on a substrate 56 and a metal plate 55 (detected part) facing the coil 57 is fixed to a key 41. According to such technique, the current (magnetic field) flowing through the coil 57 changes through relative displacement of the metal plate 55 with respect to the coil 57 at the time of key-pressing, so the key-pressing information can be detected based on such current change.

In such keyboard device, the applicant of the invention has filed a patent application for the invention shown in FIG. 12 (Patent Document 2, which was unpublished at the time of filing this application). FIG. 12 is a cross-sectional view of a conventional keyboard device 301.

As shown in FIG. 12, in the conventional keyboard device 301, a displacement member 207 (detected member) rotatably supported by a holder 10 is linked with swinging of a key 202. A detected part 208 made of non-magnetic metal is provided on the lower surface of the displacement member 207 and, the penetration amount of the detected part 208 into the region facing the coil 90 changes with the swinging of the key 202 at the time of key-pressing or key-releasing. The key-pressing information is detected based on the increase/decrease of the sensor output value accompanying the change of the penetration amount.

### PRIOR ART DOCUMENT(S)

### Patent Document(s)

[Patent Document 1] Japanese Patent Application Laid-open No. H03-048295 (e.g., lines 7 to 18in the upper left column on page 9 and FIG. 29)

[Patent Document 2] PCT/JP2022/032673 (e.g., FIGS. 11, 14)

To accurately detect the key-pressing information based on the sensor output value such as the conventional technique, a difference between the sensor output value before key-pressing and the sensor output value after key-pressing may be large. When the size of the displacement member 207 (coil 90) increases to increase such difference between the output values, issues such as an increase in size and cost of the keyboard device arise.

The invention provides a keyboard device and a method for detecting key-pressing information that can accurately detect the key-pressing information while miniaturizing a displacement member.

### SUMMARY

A keyboard device according to an embodiment of the invention includes: multiple keys, arranged in a scale direction; a displacement member, rotating by moving in conjunction with swinging of the key; a detected part, provided on an outer peripheral surface of the displacement member and being conductive; and a coil, facing the detected part and generating a magnetic field. The detected part is at least formed by a first detected part and a second detected part. The first detected part is in a curved surface shape located on a front side of the displacement member in a rotation direction, and the second detected part is connected to a rear side of the first detected part in the rotation direction and has a curvature smaller than that of the first detected part.

A keyboard device according to another embodiment of the invention includes: multiple keys, arranged in a scale direction; a displacement member, rotating by moving in conjunction with swinging of the key; a detected part, provided on an outer peripheral surface of the displacement member and being conductive; and a coil, facing the detected part and generating a magnetic field. The detected part comprises at least a plane part. Through rotation of the displacement member, the plane part is able to face the detected part.

A method for detecting key-pressing information for a keyboard device is provided. The keyboard device includes: multiple keys, arranged in a scale direction; a displacement member, rotating by moving in conjunction with swinging of the key; a detected part, provided on an outer peripheral surface of the displacement member and being conductive; and a coil, facing the detected part and generating a magnetic field. The method includes detecting the key-pressing information of the key by relatively displacing the detected part with respect to the coil, the detected part being at least formed by a first detected part and a second detected part, wherein the first detected part is in a curved surface shape located on a front side of the displacement member in a rotation direction, and the second detected part is connected to a rear side of the first detected part in the rotation direction and has a curvature smaller than that of the first detected part.

### BRIEF DESCRIPTION OF THE DRAWINGS

FIG. 1 is a cross-sectional view of a keyboard device according to a first embodiment.

FIG. 2 is an exploded perspective view of the keyboard device showing a state where a white key and a displacement member have been removed.

FIG. 3 is a perspective view of the holder.

FIG. 4A is a partially enlarged cross-sectional view of the keyboard device showing a state before inserting a guide pin of a linkage member into a groove of a displacement member, and FIG. 4B is a partially enlarged cross-sectional view of the keyboard device showing the displacement member rotated by its own weight.

FIG. 5 is an exploded perspective view of the keyboard device showing a state where a substrate and a fixed member have been removed.

FIG. 6A is a side view of the keyboard device as viewed from a direction of an arrow VIa in FIG. 5, and FIG. 6B is a side view of a keyboard device 1 showing a process for attaching the substrate to the holder and the fixed member.

FIG. 7A is a partially enlarged cross-sectional view of the keyboard device showing the state during a state in the middle of key-pressing in which a white key is pressed from the state shown in FIG. 1, and FIG. 7B is a partially enlarged cross-sectional view of the keyboard device showing a state where the white key that is further pressed from the state shown in FIG. 7A has come into contact with a key-pressing stopper.

FIG. 8A is a partially enlarged cross-sectional view of the keyboard device showing a state where the white key has been further pushed in from the state shown in FIG. 7B, and FIG. 8B is a graph showing a relationship between a stroke length of a white key 2a and a sensor output value.

FIG. 9A is a partially enlarged cross-sectional view of the keyboard device along a line IXa-IXa in FIG. 7B, and FIG. 9B is a partially enlarged cross-sectional view of the keyboard device along a line IXb-IXb in FIG. 8A.

FIG. 10 is a cross-sectional view of a keyboard device in a second embodiment.

FIG. 11A is a partially enlarged cross-sectional view of the keyboard device showing an enlarged view of an XIa portion in FIG. 10, and FIG. 11B is a partially enlarged cross-sectional view of the keyboard device showing the state where the white key is pressed from the state in FIG. 11A to the terminal position of aftertouch.

FIG. 12 is a cross-sectional view of a conventional keyboard device 301.

### DESCRIPTION OF THE EMBODIMENTS

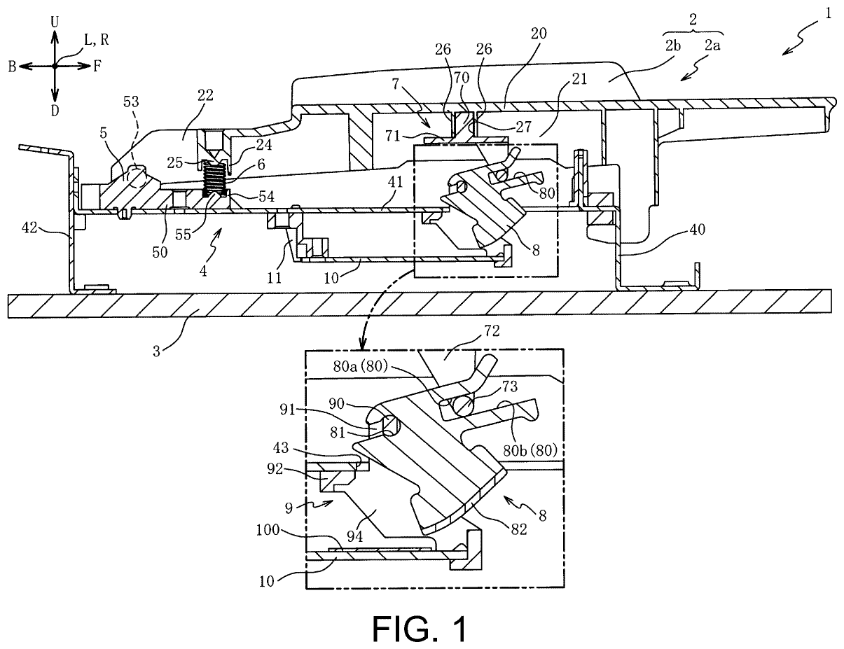

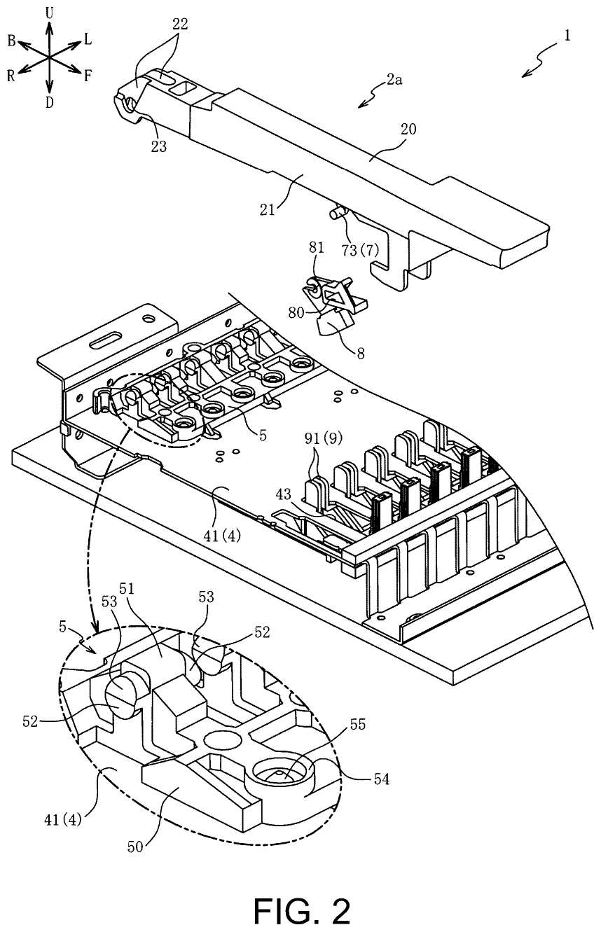

The following description refers to the attached drawings to explain exemplary embodiments. Firstly, referring to FIG. 1, the overall configuration of the keyboard device 1 of the first embodiment will be described. FIG. 1 is a cross-sectional view of a keyboard device 1 in the first embodiment. An arrow U-D direction, an arrow F-B direction, and an arrow L-R direction in FIG. 1 indicate the upper-lower direction, the front-rear direction, and the left-right direction (the direction in which multiple keys 2 are arranged, hereinafter referred to as the “scale direction”) of the keyboard device 1, respectively, and the same applies to FIG. 2 and subsequent figures. FIG. 1 is a cross-sectional view of the keyboard device 1 cut along a plane perpendicular to the scale direction.

As shown in FIG. 1, the keyboard device 1 includes multiple (in this embodiment, 88) keys 2, and is a device that forms a keyboard instrument (synthesizer). The keys 2 are formed by multiple (in the embodiment, 52) white keys 2a for playing natural notes and multiple (in this embodiment, 36) black keys 2b for playing derived notes, and the white keys 2a and the black keys 2b are arranged in the scale direction (arrow L-R direction).

The keyboard device 1 includes a base plate 3 for supporting the keys 2. The base plate 3 is formed in a plate shape extending in the scale direction by using a synthetic resin or a steel plate, and a chassis 4 is supported on the upper surface of the base plate 3.

A front leg part 40 is provided at a front end portion (the end on the arrow F side) of the chassis 4, and the front leg part 40 is fixed to the base plate 3. The front leg part 40 extends upward from the base plate 3, and from the upper end of the front leg part 40, a support part 41 for supporting the key 2 extends toward the rear side (arrow B side). The front leg part 40 and the support part 41 are integrally formed by performing a bending machining process on a metal plate.

The rear end of the support part 41 is fixed (screwed or welded) to a rear leg part 42 made of metal and extending in the upper-lower direction, and the chassis 4 formed of the respective parts 40 to 42 is formed in a C-shape having a space between the support part 41 and the base plate 3 when viewed in the scale direction.

Next, referring to FIG. 1 and FIG. 2, the configuration for rotating the white key 2a and the configuration for linking a displacement member 8 to the rotation of the white key 2a will be explained in detail. However, such configuration is substantially the same for the black key 2b. Therefore, the effects produced by the configuration of the white key 2a described below are similarly achieved in the black key 2b as well. FIG. 2 is an exploded perspective view of the keyboard device 1 showing the state with the white key 2a and the displacement member 8 removed.

As shown in FIGS. 1 and 2, the white key 2a includes an upper plate 20 whose upper surface (the surface on the arrow U side) is configured as a key-pressing surface to be pressed down by a performer, and a pair of side plates 21 extending downward from both ends of the upper plate 20 in the left-right direction (arrow L-R direction). The plate-shaped upper plate 20 and side plates 21 are integrally formed by using a resin material, and the white key 2a is formed in a box shape with an opening at the bottom.

A plate-shaped protrusion part 22 protrudes rearward from the rear end (the end on the arrow B side) of the white key 2a. The protrusion part 22 is provided as a pair spaced apart in the scale direction (arrow L-R direction) (see FIG. 2), and the pair of protrusion parts 22 are supported by a key shaft member 5.

The key shaft member 5 includes an attached part 50 that is attached to the upper surface of the chassis 4 (support part 41). The attached part 50 is formed to be substantially plate-shaped and extends in the scale direction, and, from the rear end side of the attached part 50, an insertion part 51 (see the enlarged portion in FIG. 2) rises upward.

The insertion part 51 is arranged side-by-side in the scale direction, and, at the upper end side of the insertion part 51, a substantially cylindrical shaft part 52 is formed. The parts 50 to 52 of the respective key shaft members 5 are integrally formed by using a resin material (synthetic resin).

The shaft part 52 protrudes in both sides of the scale direction from the insertion part 51, and in each of the pair of protrusion parts 22 of the white key 2a, a circular insertion hole 23 allowing insertion of the shaft part 52 is formed. When inserting the shaft part 52 into the insertion hole 23, the insertion is guided by an inclined surface 53 (see the enlarged portion in FIG. 2) formed on the shaft part 52.

The inclined surface 53 is inclined upward so as to diagonally cut off (approaching the insertion part 51) the upper end of the tip end surface of the shaft part 52. Therefore, by pushing down the pair of protrusion parts 22 of the white key 2a from the upper side toward the insertion part 51 (inserting the insertion part 51 between the pair of protrusion parts 22), the protrusion parts 22 slide along the inclined surface 53 of the shaft part 52. Through such sliding, the pair of protrusion parts 22 elastically deform to expand an interval therebetween. Therefore, the shaft part 52 can be easily inserted into the insertion hole 23 of the white key 2a. By inserting each of the pair of shaft parts 52 into the insertion hole 23, the white key 2a is supported by the key shaft member 5.

On the upper surface of the front end side (the end on the arrow F side) of the attached part 50, a cylindrical shaped retention wall 54 is formed for holding a coil spring 6 (see FIG. 1), and the retention walls 54 are arranged in side-by-side in the scale direction. At the central portion of the inner peripheral side of each retention wall 54, a conical shaped convex part 55 protruding upward is formed.

On the white key 2a, a retention wall 24 (see FIG. 1) is formed at a position facing the retention wall 54 in the upper-lower direction. The retention wall 24 is formed in a cylindrical shape extending downward from the upper plate 20 of the white key 2a, and on the inner peripheral side of the retention wall 24, a conical-shaped convex part 25 protruding downward is formed. The coil spring 6 is held on the inner peripheral side of the retention walls 24, 54 by being sandwiched from top and the bottom by the convex part 55 of the key shaft member 5 and the convex part 25 of the white key 2a. When the white key 2a is pressed, a key-pressing feel is provided by the elastic force of the coil spring 6, while when the key is released, the white key 2areturns to the initial position by the elastic recovery force of the coil spring 6.

At the approximate central portion of the white key 2a in the front-rear direction (arrow F-B direction), a plate-shaped partition plate 26 (see FIG. 1) extending downward from the upper plate 20 is formed. The partition plates 26 are provided as a pair with an interval therebetween in the front-rear direction. The partition plate 26 is integrally formed with the upper plate 20 and the side plates 21 so as to connect the pair of side plates 21 in the scale direction, and a linkage member 7 is attached to a recess part 27 surrounded by the respective plates 20, 21, 26.

The linkage member 7 is a component for linking the displacement member 8 to the swinging of the white key 2a at the time of key-pressing and key-release. The linkage member 7 includes a columnar inserted part 70 extending in the upper-lower direction, a plate-shaped extension part 71 projecting forward and backward from the lower end of the inserted part 70, and a plate-shaped protrusion part 72 (see the enlarged portion in FIG. 1) protruding downward from the front end portion of the extension part 71. The parts 70-72 are integrally formed by using a resin material.

The inserted part 70 is formed in a shape corresponding to the recess 27 of the white key 2a, and the linkage member 7 is attached to the white key 2a by inserting the inserted part 70 into the recess 27 and adhering the inserted part 70 to the white key 2a. At the lower end of the protrusion part 72, a cylindrical guide pin 73 protruding in the scale direction (arrow R side) is integrally formed, and the guide pin 73 is hooked to a groove 80 formed in the displacement member 8.

The groove 80 is a groove that penetrates the two side surfaces of the displacement member 8 facing the scale direction and extends in a direction perpendicular to the scale direction (inclined upward toward the upper front side at the initial position before key-pressing of the white key 2a). In the initial position before the white key 2a is pressed (the state shown in FIG. 1), the groove 80 extends to intersect with the displacement trajectory of the guide pin 73 around the shaft part 52. The displacement member 8 is linked to the rotation of the white key 2a by the sliding of the guide pin 73 along the groove 80. In the following description, among the groove 80 of the displacement member 8, the upper and lower surfaces on which the guide pin 73 slides at the time of key-pressing (key-release) of the white key 2a are referred to as an upper slide surface 80a and a lower slide surface 80b.

The displacement member 8 has a shaft hole 81 that penetrates through the displacement member 8 in the scale direction, and a rotation shaft 90 (see FIG. 1) formed on the holder 9 is inserted into the shaft hole 81. Accordingly, the displacement member 8 is rotatably supported on the holder 9. In the following description, in the state where the displacement member 8 is supported on the rotation shaft 90, the outer surface of the displacement member 8 facing a direction perpendicular to the axial direction (scale direction) of the rotation shaft 90 is referred to as the “outer peripheral surface”.

On the outer peripheral surface of the displacement member 8, a detected part 82 (see the enlarged portion in FIG. 1) is formed by adhering a metal plate or applying plating. A substrate 10 is provided at a position facing the detected part 82 (below the displacement member 8), and a coil 100 (see the enlarged portion in FIG. 1) that generates a magnetic field is formed on the substrate 10.

The coil 100 is formed by a conductive pattern on the substrate 10, but in FIG. 1, the coil 100 (thickness of the coil 100) on the substrate 10 is schematically illustrated. As will be described in detail later, the key-pressing information of the white key 2a is detected through the displacement of the detected part 82 of the displacement member 8 towards the region facing the coil 100 (hereinafter referred to as the “detection region”).

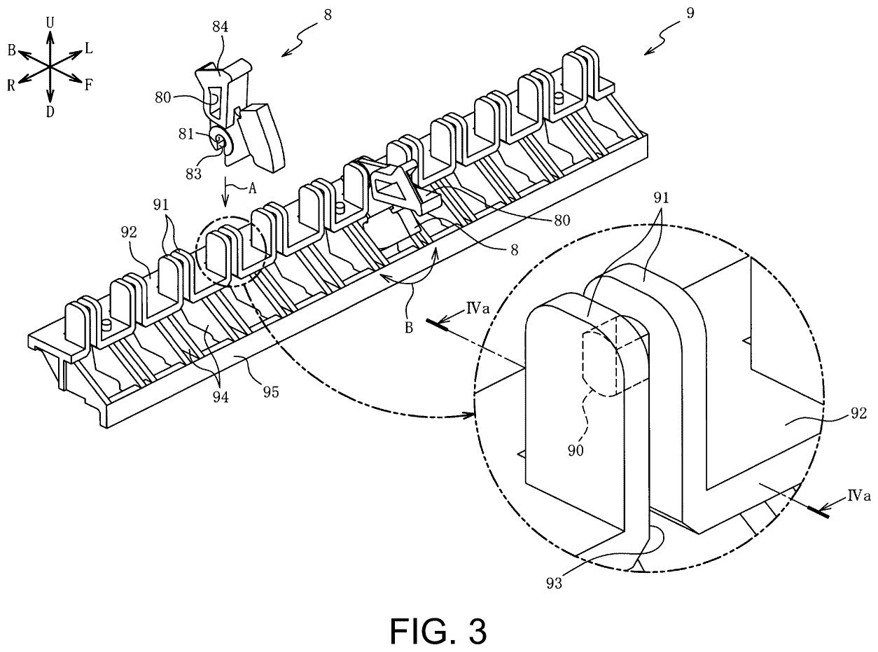

Next, referring to FIG. 3, the detailed configuration of the holder 9 will be described, together with reference to FIG. 1 and FIG. 2 as appropriate. FIG. 3 is a perspective view of the holder 9. It should be noted that FIG. 3 illustrates the holder 9 viewed from the same angle as in FIG. 2.

As shown in FIG. 3, the holder 9 includes a plate-shaped wall part 91 with an integrally formed rotation shaft 90 (see the enlarged portion in FIG. 3), and the interval between a pair of the wall parts 91 facing each other in the scale direction is connected by the rotation shaft 90. The rotation shaft 90 is formed in an elliptical shape extending vertically, and the displacement member 8 has a notch 83 formed for inserting the rotation shaft 90 into the shaft hole 81. The notch 83 is a groove (a hole penetrating through the displacement member 8 in the scale direction) that linearly connects the outer peripheral surface of the displacement member 8 to the shaft hole 81, and extends in a direction opposite to the groove 80 by sandwiching the shaft hole 81. The groove width of the notch 83 is set to be substantially the same as the front-rear direction dimension of the elliptical rotation shaft 90 (the width dimension of the rotation shaft 90 in the arrow F-B direction).

Therefore, as indicated by the arrow A in FIG. 3, by inserting the displacement member 8 between the pair of the wall parts 91, so that the rotation shaft 90 is inserted into the notch 83 in the state in which the notch 83 of the displacement member 8 faces downward, the rotation shaft 90 is inserted into the shaft hole 81. The diameter of the shaft hole 81 is substantially the same as the upper-lower direction dimension of the rotation shaft 90 (the longitudinal dimension of the rotation shaft 90 in the arrow U-D direction). After the rotation shaft 90 is inserted into the shaft hole 81 from the notch 83, by rotating the displacement member 8 to orient the notch 83 toward the rear side (arrow B side), the displacement member 8 is pivotally supported by the rotation shaft 90.

The holder 9 includes an attached part 92 that is substantially plate-shaped and extends in the scale direction, and the attached part 92 is attached to the support part 41 of the chassis 4 (see FIG. 1). Multiple wall parts 91 arranged in the scale direction stand upward from the attached part 92, and if the wall parts 91 provided as a pair and sandwiching the displacement member 8 is considered as one set, multiple sets of wall parts 91 are arranged in the scale direction. In the embodiment, the displacement members 8 for one octave (12 keys) are pivotally supported by one holder 9. The attached part 92 is fixed (screwed) to the lower surface of the support part 41 of the chassis 4 (see FIG. 1), and the wall parts 91 are inserted from below into through holes 43 (see FIG. 2) formed in the support part 41.

A through hole 93 (see the enlarged portion in FIG. 3) penetrating through the attached part 92 in the upper-lower direction is formed between the pair of wall parts 91, and a portion of the displacement member 8 is inserted into this through hole 93. That is, in the state where the displacement member 8 is pivotally supported by the holder 9, the portion on the lower end side of the displacement member 8 is positioned below the attached part 92 (the support part 41 of the chassis 4) (see FIG. 1), and the displacement of the displacement member 8 in such position is allowed by the through hole 93.

A hanging part 94 that is in a plate shape descends and has a downward inclination towards the front lower side from the attached part 92 of the holder 9. Considering a pair of the hanging parts 94 facing each other by sandwiching the displacement member 8 as one set, multiple sets of hanging parts 94 are aligned in the scale direction, and the lower ends of the sets of hanging parts 94 are connected in the scale direction by a connection part 95. Each of the parts 91 to 95 of the holder 9 including the rotation shaft 90 is integrally formed using a resin material. However, the holder 9 may also be formed by multiple components.

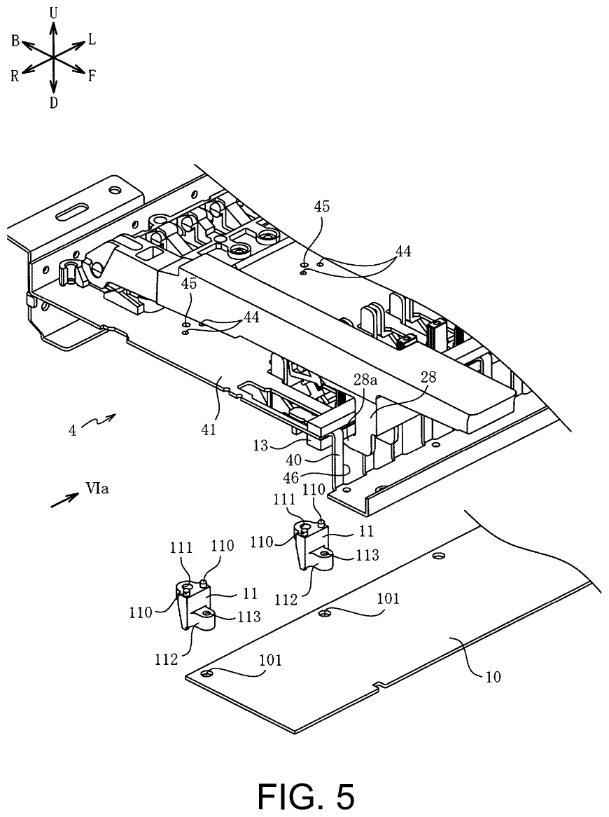

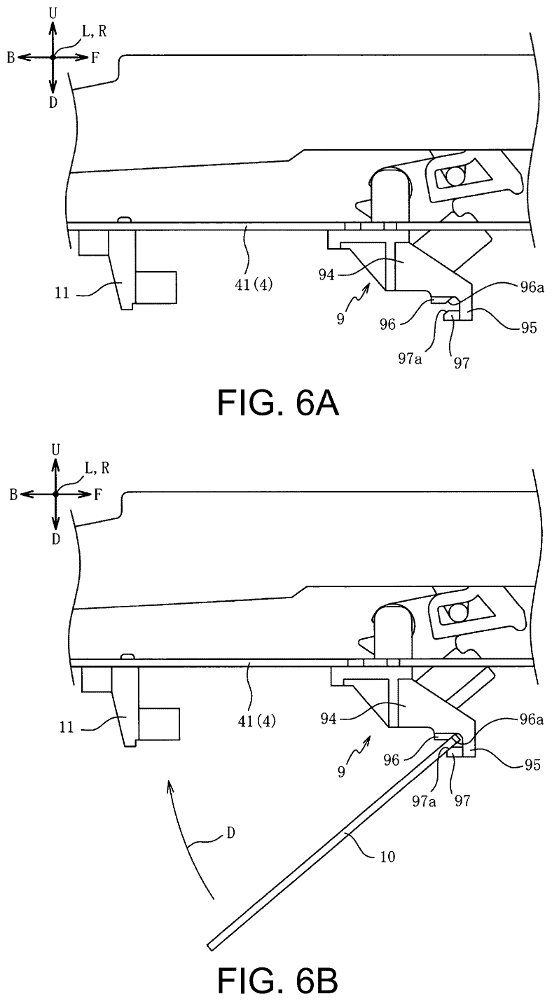

The front end of the substrate 10 (see FIG. 1) is supported on the connection part 95, and the rear end of the substrate 10 is supported on the chassis 4 (support part 41) via the fixed member 11 (see FIG. 1). The details of the support structure for the substrate 10 will be described later with reference to FIG. 5 and FIG. 6.

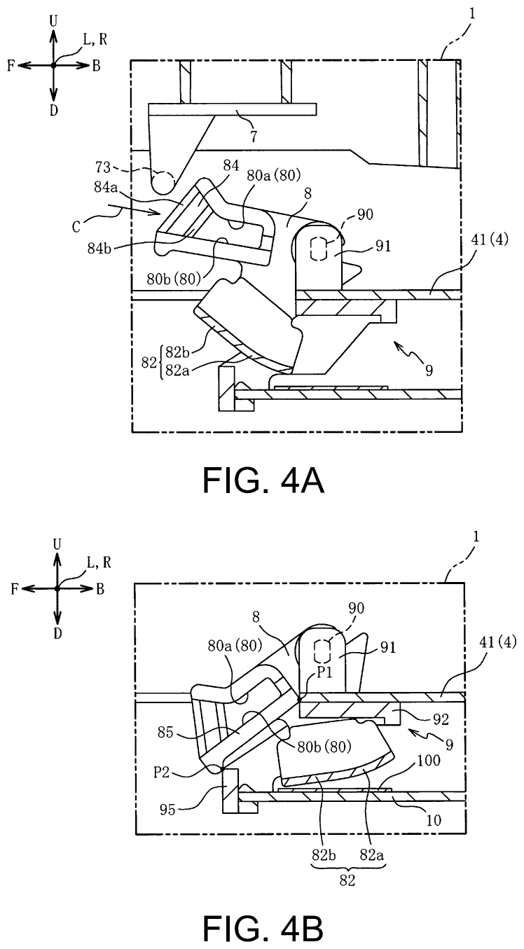

As indicated by arrow B in FIG. 3, in the state where the displacement member 8 is pivotally supported by the holder 9, it is possible to move the displacement member 8 (oscillate the displacement member 8 in the scale direction) through twisting in the scale direction. This is because, in addition to a slight gap between the rotation shaft 90 and the shaft hole 81, the pair of wall parts 91 are elastically deformable. The guide pin 73 (see FIG. 4A) of the linkage member 7 is engaged with the groove 80 through swinging of the displacement member 8 in the scale direction.

The engagement method will be described with reference to FIG. 3 and FIGS. 4A and 4B. FIG. 4A is a partially enlarged cross-sectional view of the keyboard device 1 showing a state before inserting the guide pin 73 of the linkage member 7 into the groove 80 of the displacement member 8, and FIG. 4B is a partially enlarged cross-sectional view of the keyboard device 1 showing the displacement member 8 rotated by its own weight. In FIG. 4A, the state where the holder 9 is assembled to the support part 41 of the chassis 4 is illustrated, and FIG. 4A corresponds to a cross-sectional view cut along the line IVa-IVa shown in the enlarged portion of FIG. 3. Additionally, FIGS. 4A and 4B are side views of the displacement member 8, but hatching is added to the detected part 82 for the ease of understanding.

As shown in FIG. 3 and FIGS. 4A and 4B, the groove 80 of the displacement member 8 extends in a direction away from the rotation shaft 90 (shaft hole 81 shown in FIG. 3) of the holder 9, and the groove width of the groove 80 gradually expands as the groove 80 moves away from the rotation shaft 90.

More specifically, a lower slide surface 80b (see FIG. 4A) of the displacement member 8 is a plane extending linearly in a direction substantially perpendicular to the axial direction of the rotation shaft 90 (substantially parallel to the arrow F-B direction in FIG. 4A). On the other hand, an upper slide surface 80a is formed by a plane parallel to the lower slide surface 80b, an inclined surface rising upward to the front side from the front edge (the end on the arrow F side) of the plane portion, and a curved surface smoothly connecting the plane and the inclined surface.

An opening of the groove 80 is formed on the outer peripheral surface of the displacement member 8 by the front edge of the inclined surface of the upper slide surface 80a and the front edge of the lower slide surface 80b. The guide pin 73 of the linkage member 7 is inserted through the opening along an insertion direction C. The insertion direction C of the guide pin 73 is the same direction as the sliding direction of the guide pin 73 along the groove 80 (where the upper and lower slide surfaces 80a, 80b face each other in parallel).

In the displacement member 8, a regulation wall 84 connecting the inclined surface of the upper slide surface 80a and the front end portion of the lower slide surface 80b is formed at the opening portion of the groove 80. The regulation wall 84 is a wall for regulating the guide pin 73 of the linkage member 7 from coming out of the groove 80. While not shown herein, in the assembled state of the white key 2a (the state shown in FIG. 1) where the guide pin 73 is engaged with the groove 80, the regulation wall 84 is disposed at a position overlapping with the guide pin 73 in the insertion direction C of the guide pin 73.

Therefore, in the state where the white key 2a is pivotally supported by the key shaft member 5 (see FIG. 1), if the guide pin 73 is simply inserted from the opening of the groove 80 along the insertion direction C, the insertion may interfere with the regulation wall 84. Such interference can be largely avoided by the swinging of the displacement member 8 as indicated by arrow B in FIG. 3. However, in the embodiment, a front inclined surface 84a (see FIG. 4A) is formed on the side surface of the regulation wall 84 to facilitate the insertion of the guide pin 73 into the groove 80 more easily. The side surface of the regulation wall 84 refers to a surface facing the side (the front side in the direction perpendicular to the paper surface in FIG. 4A) opposite to the protrusion direction of the guide pin 73 in the scale direction.

The front inclined surface 84a is inclined to obliquely cut out the front edge portion of the side surface of the regulation wall 84. Therefore, at the time of inserting the guide pin 73 from the opening of the groove 80 along the insertion direction C, by slightly causing the oscillation of the displacement member 8 as indicated by arrow B in FIG. 3 (slightly twisting the displacement member 8 toward the back side in the direction perpendicular to the paper surface in FIG. 4A), the guide pin 73 can be engaged in the groove 80 while sliding along the front inclined surface 84a. As a result, the guide pin 73 can be easily engaged in the groove 80, thereby improving the workability of the assembly process of the white key 2a.

In addition, a rear inclined surface 84b is also formed on the side surface of the regulation wall 84. The rear inclined surface 84b is inclined to obliquely cut out the rear edge (the end on the arrow B side) portion of the side surface of the regulation wall 84. Therefore, at the time of pulling out the guide pin 73 from the groove 80 in the direction opposite to the insertion direction C, by slightly swinging the displacement member 8 as indicated by arrow B in FIG. 3 (slightly twisting the displacement member 8 toward the back side in the direction perpendicular to the paper surface in FIG. 4A), the guide pin 73 can be removed from the groove 80 while sliding along the rear inclined surface 84b. As a result, the guide pin 73 can be easily removed from the groove 80, thereby improving the workability of replacement and maintenance operations of the white key 2a.

Here, as shown in FIG. 4B, in the state where the guide pin 73 is not engaged in the groove 80, the displacement member 8 rotates around the rotation shaft 90 due to its own weight. When the displacement member 8 contacts the coil 100 on the substrate 10 due to the rotation, there is a risk that the coil 100 may be damaged.

If the detected part 82 of the displacement member 8 is formed in one arc shape centered on the rotation shaft 90, even if the displacement member 8 rotates around the rotation shaft 90 due to its own weight, the detected part 82 does not contact the coil 100. However, as will be described in detail later, the detected part 82 of the embodiment is formed by a curved surface part 82a in an arc shape centered on the rotation shaft 90, and a plane part 82b in a line shape connected to the front edge of the curved surface part 82a. Therefore, in the case where the guide pin 73 is removed from the groove 80, if the displacement member 8 rotates around the rotation shaft 90 due to its own weight, there is a risk that the plane part 82b of the detected part 82 may contact the coil 100.

In contrast, the embodiment has a configuration that can prevent such contact between the plane part 82b and the coil 100. Specifically, a convex part 85 protrudes from the side surface of the displacement member 8, the convex part 85 surrounding the groove 80 (upper and lower slide surfaces 80a, 80b), and the wall part 91 (attached part 92) of the holder 9 is formed on the displacement trajectory around the rotation shaft 90. The configuration is such that in the case where the displacement member 8 rotates around the rotation shaft 90 due to its own weight, the wall part 91 (attached part 92) of the holder 9 contacts the convex part 85 at the contact point P1 before the plane part 82b of the detected part 82 contacts the coil 100.

Additionally, the configuration is such that simultaneously with the contact between the wall part 91 and the convex part 85 at the contact point P1, the connection part 95 of the holder 9 also contacts the displacement member 8 at a contact point P2. In other words, a portion of the holder 9 (the wall part 91, the attached part 92, and the connection part 95) positioned on the displacement trajectory of the displacement member 8 functions as a regulation member that regulates the contact between the detected part 82 (plane part 82b) and the coil 100.

As a result, even in the case where the detected part 82 is not in one arc shape centered on the rotation shaft 90 (for example, when the plane part 82b is formed), the holder 9 can regulate the contact between the detected part 82 and the coil 100 when the displacement member 8 rotates around the rotation shaft 90 due to its own weight. Therefore, damage to the coil 100 due to such contact can be prevented.

Next, referring to FIG. 5 and FIG. 6, the attachment structure of the substrate 10 will be described. FIG. 5 is an exploded perspective view of the keyboard device 1 showing the state where the substrate 10 and the fixed member 11 are removed. FIG. 6A is a side view of the keyboard device 1 as viewed in the direction of arrow VIa in FIG. 5, and FIG. 6B is a side view of the keyboard device 1 showing the process of mounting the substrate 10 to the holder 9 and the fixed member 11. FIG. 6A illustrates the state where the fixed member 11 is fixed to the support part 41 of the chassis 4.

As shown in FIG. 5, a pair of protrusions 110 arranged in the scale direction (arrow L-R direction) protrude from the upper surface of the fixed member 11, and through holes 44 are formed in the support part 41 of the chassis 4 at positions corresponding to the protrusions 110. By inserting the pair of protrusions 110 into the through holes 44, the attachment position of the fixed member 11 relative to the support part 41 is determined.

On the rear side with respect to the pair of protrusions 110, a through hole 111 is formed to penetrate through the fixed member 11 in the upper-lower direction. The fixed member 11 is attached to the lower surface of the support part 41 by inserting a screw (not shown) from below into the through hole 111 and fastening the screw to a threaded hole 45 of the support part 41 of the chassis 4.

From the front surface (the surface facing the arrow F side) of the fixed member 11, a fixed part 112 for fixing the substrate 10 protrudes toward the front side, and a threaded hole 113 extending in the upper-lower direction is formed in the fixed part 112. Multiple fixed members 11 are arranged in the scale direction, and through holes 101 are formed at positions corresponding to the threaded holes 113 of the fixed members 11 on the rear end side (the end on the arrow B side) of the substrate 10. The rear end of the substrate 10 is fixed to the fixed member 11 by inserting screws (not shown) from below into the through holes 101 of the substrate 10 and fastening the screws to the threaded holes 113 of the fixed members 11.

As shown in FIG. 6A, a protrusion 96 protrudes downward from the lower surface of the hanging part 94 of the holder 9, and a protrusion 97 protrudes rearward from the rear surface (the surface facing the arrow B side) of the connection part 95. The respective protrusions 96, 97 are integrally formed with the hanging part 94 and the connection part 95. While not shown, the respective protrusions 96, 97 are arranged in the scale direction.

An inclined surface 96a inclined upward toward the front upper side is formed on the front edge (the end on the arrow F side) of the protrusion 96, and an inclined surface 97a inclined downward toward the rear lower side is formed on the rear edge (the end on the arrow B side) of the protrusion 97. The respective inclined surfaces 96a, 97a are formed parallel to each other. The interval between the inclined surfaces 96a and 97a, and the interval between the lower surface of the protrusion 96 and the upper surface of the protrusion 97 are substantially the same as the thickness of the substrate 10.

As shown in FIG. 6B, at the time of attaching the substrate 10 to the holder 9 and the fixed member 11, firstly, the substrate 10 is inserted between the respective protrusions 96, 97 in a state where the substrate 10 is inclined to be parallel to each inclined surface 96a, 97a. Then, as indicated by arrow D, the front end of the substrate 10 is rotated between the respective protrusions 96, 97, and the rear end of the substrate 10 is screwed to the fixed member 11. As a result, the substrate 10 is supported on the support part 41 of the chassis 4 via the holder 9 and the fixed member 11.

In this way, in the embodiment, the substrate 10 is supported on the holder 9 by inserting the front end of the substrate 10 between the respective protrusions 96, 97 (insertion part). In other words, the substrate 10 is merely inserted between the protrusions 96, 97 without being screwed to the holder 9, so the need for forming through holes (such as through holes 101) for screwing to the holder 9 in the front end portion of the substrate 10 can be eliminated. Accordingly, the front-rear direction dimension of the substrate 10 can be shortened, and the manufacturing cost of the substrate 10 can be reduced.

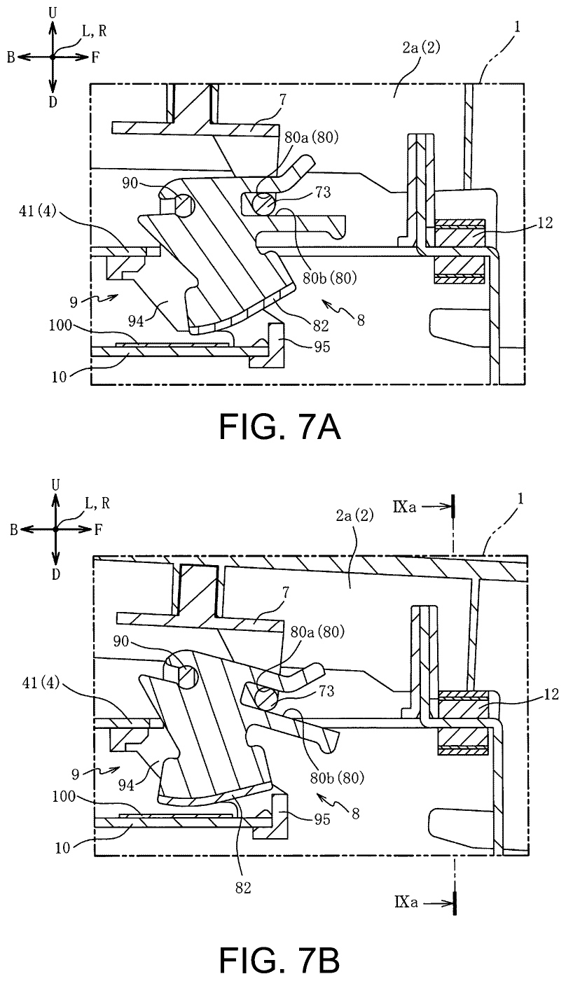

Next, referring to FIGS. 7A and 7B, the operation of the displacement member 8 associated with the pressing (releasing) of the white key 2a will be described. FIG. 7A is a partially enlarged cross-sectional view of the keyboard device 1 showing a state during key-pressing (before the white key 2a contacts the key-pressing stopper 12) from the state shown in FIG. 1, and FIG. 7B is a partially enlarged cross-sectional view of the keyboard device 1 showing a state where the white key 2a, further pressed from the state in FIG. 7A, has come into contact with the key-pressing stopper 12.

As shown in FIGS. 7A and 7B, at the time when the white key 2a is pressed, the guide pin 73 rotates downward (clockwise in FIGS. 7A and 7B). At this time, the lower slide surface 80b is pushed in by the guide pin 73. As a result, the displacement member 8 rotates around the rotation shaft 90 of the holder 9 (clockwise in FIGS. 7A and 7B).

Together with the rotation, the detected part 82 of the displacement member 8 relatively displaces with respect to the substrate 10 supported by the holder 9. In other words, as the stroke length of the white key 2a increases from the state before key-pressing, the penetration amount of the detected part 82 into the detection region increases. The penetration amount of the detected part 82 refers to the size of the area where the detected part 82 and the coil 100 face each other in the thickness direction (upper-lower direction) of the substrate 10.

Meanwhile, in the case where the white key 2a is released after being pressed, the guide pin 73 rotates (counterclockwise in FIGS. 7A and 7B) to return to the initial position due to the elastic force of the coil spring 6 (see FIG. 1). Through the rotation of the guide pin 73, the upper slide surface 80a of the groove 80 is pushed up by the guide pin 73, so that the displacement member 8 rotates around the rotation shaft 90 (counterclockwise in FIGS. 7A and 7B). At this time, the penetration amount of the detected part 82 into the detection region decreases.

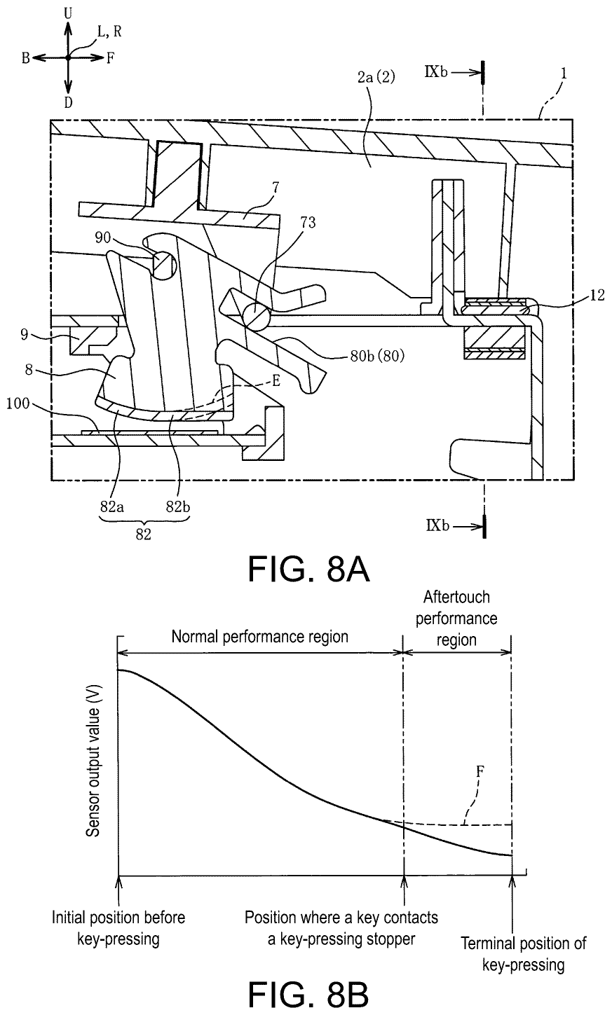

The detected part 82 is formed using a non-magnetic metal (such as copper). Therefore, in a state where a magnetic field is generated by flowing a current through the coil 100, as the penetration amount of the detected part 82 into the detection region increases, the inductance of the coil 100 decreases, and as the penetration amount of the detected part 82 into the detection region decreases, the inductance of the coil 100 increases. Based on this increase and decrease in the inductance of the coil 100, the sensor output value (V) changes (see FIG. 8B). The key-pressing information (note information) is detected based on the increase/decrease in the sensor output value.

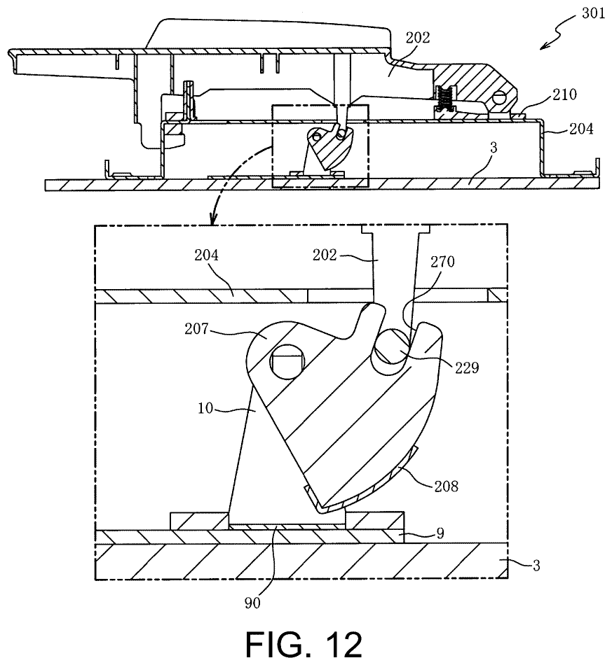

Regarding the technology for detecting key-pressing information by using such non-contact sensor, the applicant of the invention has filed a patent application for the invention shown in FIG. 12 (PCT/JP2022/032673, which was unpublished at the time of filing this application). FIG. 12 is a cross-sectional view of a conventional keyboard device 301.

In the conventional keyboard device 301, an issue arises where the initial position (angle) of the displacement member 207 before key-pressing, or the displacement amount (rotation amount) of the displacement member 207 together with key-pressing may deviate from the design value.

As a reason why such issue occurs, in the structure shown in FIG. 12, while the holder 210 that rotatably supports the key 202 is fixed to the chassis 204, the holder 10 that rotatably supports the displacement member 207 is fixed to the base plate 3 via the substrate 9. In other words, because the key 202 and the displacement member 207 are assembled to different components, the relative positional accuracy between the key 202 and the displacement member 207 tends to decrease due to assembly errors, etc. As a result, the engagement position between a guide pin 229 of the key 202 and a groove 270 of the displacement member 207 tend to easily deviate from the design value.

Comparatively, in the embodiment, as shown in FIGS. 7A and 7B, the structure includes the chassis 4 (first support member), the white key 2a (multiple keys 2) pivotally supported by the chassis 4, the displacement member 8 that moves in conjunction with the swinging of the white key 2a, the holder 9 (second support member) that supports the displacement member 8 in a displaceable manner and is attached to the chassis 4, and the coil 100 (sensor) that faces the detected part 82 of the displacement member 8 and detects the displacement of the displacement member 8.

In other words, because the white key 2a and the holder 9 to which the displacement member 8 is pivotally supported are assembled to the same chassis 4, the relative positional accuracy between the white key 2a and the displacement member 8 can be improved. As a result, the guide pin 73 of the linkage member 7 and the groove 80 of the displacement member 8 can be accurately engaged at the position as designed. Therefore, the initial position (angle) of the displacement member 8 before key-pressing and the displacement amount (rotation amount) of the displacement member 8 accompanying key-pressing are more likely to follow the design value. Consequently, the key-pressing information of the white key 2a can be detected with high accuracy.

Moreover, at the initial position before key-pressing (the state shown in FIG. 1), the lower slide surface 80b of the groove 80 is inclined upward towards the upper front side. When the displacement member 8 rotates until an angle where the lower slide surface 80b is along the horizontal direction at the time of key-pressing, the guide pin 73 slides toward the rear end side (arrow B side) of the lower slide surface 80b (see FIG. 1 and FIG. 7A). On the other hand, at the time when the displacement member 8 rotates further from the angle where the lower slide surface 80b is along the horizontal direction at the time of key-pressing, the guide pin 73 slides towards the front end side (arrow F side) of the lower slide surface 80b (see FIG. 7A and FIG. 7B).

That is, because the sliding direction of the guide pin 73 along the groove 80 reverses midway through key-pressing (the guide pin 73 moves back and forth in the groove 80 at the time of key-pressing), the sliding range of the guide pin 73 relative to the groove 80 can be narrowed. As a result, the groove 80 can be formed shorter, so the shape accuracy of the groove 80 is increased easily. Accordingly, it becomes easier for the engagement position of the guide pin 73 and the groove 80 to conform to the design value. Therefore, the key-pressing information of the white key 2a can be accurately detected.

Additionally, since the substrate 10 is directly attached to the holder 9 to which the displacement member 8 is pivotally supported, the relative position accuracy between the displacement member 8 and the coil 100 on the substrate 10 can also be improved. As a result, the clearance between the coil 100 and the detected part 82 of the displacement member 8 is more likely to conform to the dimensions in accordance with the design values. Therefore, the key-pressing information of the white key 2a can be accurately detected.

In the embodiment, the substrate 10 is directly attached to the holder 9, but it may also be configured that the substrate 10 is attached to a support component provided separately from the holder 9. As an example of the configuration, a structure as follows is shown: the hanging part 94 and the connection part 95 of the holder 9 are omitted, the substrate 10 is extended toward the front side (arrow F side), and the front end portion of the substrate 10 is supported by a component similar to the fixed member 11 (see FIG. 6). Even in such a structure, because the substrate 10 on which the coil 100 is provided and the holder 9 to which the displacement member 8 is pivotally supported can be supported on the same chassis 4, the clearance between the coil 100 and the detected part 82 is more likely to conform to the dimensions according to the design values. Consequently, the key-pressing information of the white key 2a can be detected with high accuracy.

Here, it is possible to integrally form the key shaft member 5 (see FIG. 2) that supports the white key 2a to be swingable, or the fixed member 11 (see FIG. 6) to which the rear end of the substrate 10 is fixed, with the holder 9. However, if the components are integrally formed, the components become larger, making it easier for errors to occur in the dimensions of the components themselves (for example, in the length in the front-rear direction). When such dimensional errors occur, the engagement position of the guide pin 73 and the groove 80, or the clearance between the detected part 82 and the coil 100 becomes more likely to deviate from the design value. Consequently, the key-pressing information of the white key 2a cannot be detected with high accuracy.

Comparatively, in the embodiment, because the key shaft member 5 (see FIG. 2), the holder 9, and the fixed member 11 are separate components, each of the components can be miniaturized. As a result, the dimensional accuracy of the key shaft member 5, the holder 9, and the fixed member 11 themselves is more likely to improve.

Also, while not shown, the key shaft member 5 (see FIG. 2) pivotally supports keys 2 for one octave, and as mentioned above, the holder 9 pivotally supports displacement members 8 for one octave (12 pieces) (see FIG. 3).

That is, multiple key shaft members 5 and holders 9 are arranged in the scale direction. Accordingly, compared to a configuration where all the keys 2 arranged in the scale direction are pivotally supported by one key shaft member 5, or a configuration where all displacement members 8 arranged in the same direction are pivotally supported by one holder 9, the key shaft member 5 and the holder 9 can be miniaturized. Therefore, the dimensional accuracy of the key shaft member 5 or the holder 9 themselves is easily improved.

Also, as mentioned above, because the fixed members 11 (see FIG. 6) are also arranged in the scale direction, the fixed members 11 can be made smaller than the case where the substrate 10 is supported by one fixed member 11 extending in the scale direction. As a result, the dimensional accuracy of the fixed member 11 itself is more likely to improve.

In this way, by improving the dimensional accuracy of the key shaft member 5, the holder 9, and the fixed member 11 themselves, the engagement position of the guide pin 73 and the groove 80, or the clearance between the detected part 82 and the coil 100, is more likely to conform to the design value. Consequently, the key-pressing information of the white key 2a can be detected with high accuracy.

As shown in FIG. 7B, the swinging of the white key 2a at the time of being pressed is regulated by the key-pressing stopper 12. The key-pressing stopper 12 is a cushioning material adhered to the upper surface on the front end side of the support part 41 of the chassis 4, and the region until the lower surface of the white key 2a contacts the key-pressing stopper 12 at the time of key-pressing is the normal performance region. Meanwhile, the performance that presses the key deeper than the terminal position of normal performance (the state shown in FIG. 7B where the white key 2a is in contact with the key-pressing stopper 12) is the aftertouch performance region. When the aftertouch performance is executed, a musical sound different from that at the time of normal performance, such as a musical sound with a different tone or a musical sound to which an effect (changes in volume or vibrato) is applied, is generated.

In the embodiment, in addition to the key-pressing information during normal performance, the key-pressing information at the time of aftertouch performance is also detected based on a change in the magnetic field of the coil 100 (increase or decrease in sensor output value). The detection method for such performance will be described with reference to FIGS. 7A and 7B and FIGS. 8A and 8B.

FIG. 8A is a partially enlarged cross-sectional view of the keyboard device 1 showing a state where the white key 2a is further pushed in from the state shown in FIG. 7B, and FIG. 8B is a graph showing a relationship between the stroke length of the white key 2a and the sensor output value, where the vertical axis indicates the magnitude (V) of the sensor output value, and the horizontal axis indicates the stroke length of the key 2 of the white key 2a. In FIG. 8B, for ease of understanding, the range of the aftertouch performance region and the change in sensor output value are schematically illustrated.

As shown in FIG. 8A, when the white key 2a is further pushed in from the terminal position of normal performance (the state in FIG. 7B), the key-pressing stopper 12 is compressed by the white key 2a, while the lower slide surface 80b of the groove 80 is pushed downward by the guide pin 73 of the linkage member 7. As a result, the penetration amount of the detected part 82 into the detection region further increases.

As shown in FIG. 8B, as the penetration amount of the detected part 82 into the detection region facing the coil 100 increases, the sensor output value decreases. That is, at the time of pressing the white key 2a, the sensor output value gradually decreases as the push-in amount of the white key 2a increases. Meanwhile, at the time of releasing the white key 2a, the sensor output value gradually increases.

To accurately detect the key-pressing information based on the sensor output value, the difference (hereinafter referred to as “dynamic range”) between the sensor output value before key-pressing and the sensor output value at the terminal position of key-pressing may be large.

In particular, in the embodiment, in addition to normal performance, it is also configured to detect aftertouch performance from the change in sensor output value shown in FIG. 8B. Therefore, to accurately detect aftertouch, it is necessary to significantly decrease the sensor output value when the white key 2a in contact with the key-pressing stopper 12 is further pushed in.

The sensor output value decreases as the area where the coil 100 and the detected part 82 face each other increases, and also decreases as the distance between the coil 100 and the detected part 82 decreases. Therefore, for example, when the detected part 82 is formed in one arc shape centered on the rotation shaft 90 of the holder 9, as shown by a broken line E in FIG. 8A, the distance between the detected part 82 and the coil 100 at the time when the displacement member 8 rotates till the aftertouch performance region cannot be sufficiently close. Consequently, as shown by a broken line F in FIG. 8B, it becomes difficult for the sensor output value to decrease in the aftertouch performance region.

In other words, in the case where the detected part 82 is formed in one arc shape centered on the rotation shaft 90 of the holder 9, it becomes difficult to expand the dynamic range, so aftertouch cannot be accurately detected. Moreover, when the size of the displacement member 8 (coil 100) increases to expand the dynamic range, issues such as an increase in size and cost of the keyboard device 1 arise.

Comparatively, in the embodiment, by providing the curved surface part 82a and the plane part 82b in the detected part 82, a configuration that can accurately detect aftertouch is achieved. The configuration will be described below. In the following description regarding the detected part 82, the rotation direction of the displacement member 8 is used as a reference, with the direction in which the displacement member 8 rotates at the time of key-pressing is referred to as the front side of the detected part 82, and the opposite side is referred to as the rear side.

In the detected part 82, the part positioned on the front side (arrow B side) in the rotation direction of the displacement member 8 is the curved surface part 82a, and the part continuous with the rear side of the curved surface part 82a in the same rotation direction is the plane part 82b. The curved surface part 82a is formed in an arc shape (a curved shape convex in a direction away from the rotation shaft 90) centered on the rotation shaft 90, and the plane part 82b is formed in a plate shape extending in the tangential direction of the rear end (the end on the arrow F side) of the curved surface part 82a.

That is, since the curvature of the plane part 82b is smaller than that of the curved surface part 82a, it is possible for the distance between the coil 100 and the detected part 82 (plane part 82b) to be short in the aftertouch performance region than the case where the detected part 82 is one arc shape centered on the rotation shaft 90 as described above. Accordingly, the dynamic range can expand (with a significantly decrease in the sensor output value in the aftertouch performance region) without enlarging the displacement member 8 (coil 100). That is, it is possible to accurately detect aftertouch while miniaturizing the displacement member 8.

In particular, in the embodiment, since the plane part 82b is formed in a planar shape, it is possible for the distance between the coil 100 and the detected part 82 (plane part 82b) to be as short as possible in the aftertouch performance region than the case where the plane part 82b is a curved surface with a smaller curvature than that of the curved surface part 82a. Therefore, the dynamic range can be effectively expanded.

Furthermore, in the aftertouch performance region (the terminal position), the plane part 82b and the coil 100 (substrate 10) face each other to be substantially in parallel, so it is possible for the distance between the coil 100 and the detected part 82 (plane part 82b) as close as possible. In this way as well, the dynamic range can be effectively expanded. It should be noted that, although “substantially parallel” preferably refers to a state where the plane part 82b and the coil 100 (substrate 10) face each other to be in parallel without contacting each other, but the expression may also refer to that the plane part 82b and the coil 100 face each other to be non-parallel.

In this way, by expanding the dynamic range of the sensor output value, the key-pressing information of the white key 2a can be detected with high accuracy. Particularly, in the case where aftertouch is detected based on a change in the sensor output value, as in the embodiment, it is especially preferable to have a wide dynamic range (where the sensor output value significantly decreases in the aftertouch performance region). Accordingly, aftertouch can be accurately detected.

In the embodiment, at the initial position before key-pressing (see the enlarged portion in FIG. 1), the curved surface part 82a of the detected part 82 and the coil 100 are disposed at overlapped positions in the vertical direction (thickness direction of the substrate 10). In other words, because the curved surface part 82a of the detected part 82 and the coil 100 face each other in the upper-lower direction at the initial position before key-pressing, changes in the sensor output value associated with the rotation of the detected part 82 can be generated immediately after key-pressing. Accordingly, the key-pressing information can be accurately detected.

Here, as a conventional technology for detecting aftertouch, a technique is known where a pressure sensor is pushed by a hammer that moves in conjunction with the swinging of the key at the time of key-pressing (for example, Japanese Patent Application Laid-Open Publication No. H08-234751). In such type of keyboard device, if the key-pressing stopper that regulates the swinging of the key at the time of key-pressing is formed to be relatively rigid, the sensation of reaching the end of normal performance (hereinafter referred to as “full stroke feel”) is more easily imparted to the performer when the key contacts the stopper at the time of key-pressing.

However, if the key-pressing stopper is formed to be rigid, it becomes difficult to significantly displace the key (hammer) during aftertouch performance. Therefore, aftertouch cannot be easily detected. Meanwhile, if the key-pressing stopper is simply formed to be soft, it is difficult to obtain the full stroke feel when the key contacts the key-pressing stopper, so the performer performing normal performance may push the key into the aftertouch region.

Therefore, normal performance and aftertouch cannot be accurately distinguished. In response thereto, the key-pressing stopper 12 of the embodiment has a configuration that can solve such problems.

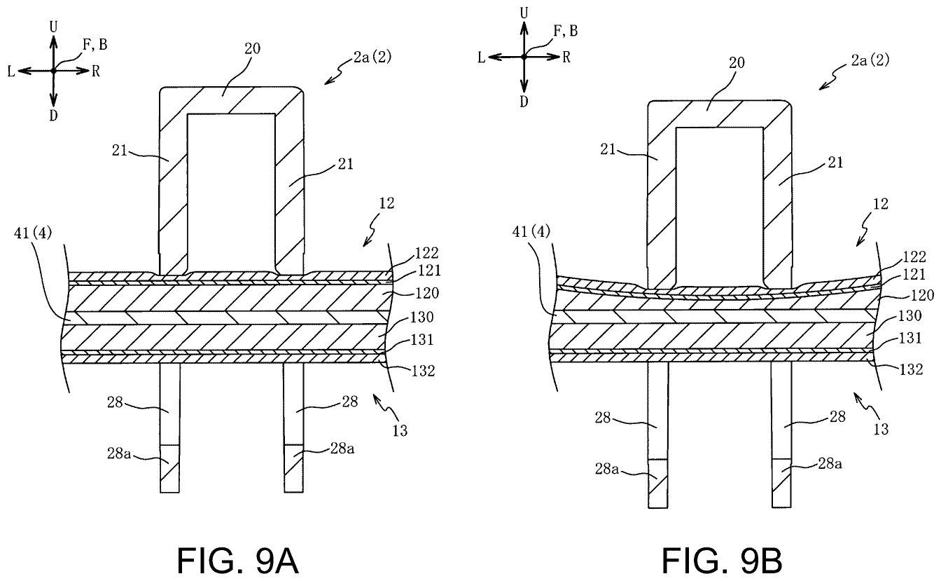

The detailed configuration of the key-pressing stopper 12 will be described with reference to FIG. 9A and FIG. 9B. FIG. 9A is a partially enlarged cross-sectional view of the keyboard device 1 along a line IXa-IXa in FIG. 7B, showing a cross-sectional view of the state where the white key 2a has swung to the terminal position of normal performance. FIG. 9B is a partially enlarged cross-sectional view of the keyboard device 1 along a line IXb-IXb in FIG. 8A, showing a cross-sectional view of the state where the white key 2a has been further pushed (aftertouch performance has been executed) from the state in FIG. 9A. It should be noted that FIG. 9 illustrates only the essential parts of the keyboard device 1, omitting the illustration of other parts (for example, the keys 2 adjacent to the white key 2a).

As shown in FIG. 9, the key-pressing stopper 12 includes a first cushion layer 120 made of foam urethane adhered to the upper surface of the support part 41 of the chassis 4 by using a double-sided tape or adhesive. On the surface layer side (on the side of the side plate 21 of the white key 2a) of the first cushion layer 120, a rigid layer 121 made of PET (polyethylene terephthalate) is laminated. Furthermore, on the surface layer side of the rigid layer 121, a second cushion layer 122 made of felt is laminated, and the layers 120 to 122 are adhered to each other by using an adhesive or a double-sided tape.

In this manner, in the embodiment, the rigid layer 121, which is more rigid than the first cushion layer 120, is laminated on the surface layer side of the relatively soft first cushion layer 120. Accordingly, as shown in FIG. 9A, in the case where the pair of side plates 21 of the white key 2a contact the key-pressing stopper 12 (second cushion layer 122) at the time of key-pressing, a relatively rigid full stroke feel can be imparted to the performer by the rigid layer 121.

Furthermore, even if the rigid layer 121 is pushed towards the side of the first cushion layer 120 by using the pair of side plates 21 during normal performance, the first cushion layer 120 is compressed as a whole by the relatively rigid layer 121 (the pushing force of the white key 2a is distributed by the rigid layer 121), so a relatively small pressure applied to the first cushion layer 120. As a result, even if the first cushion layer 120 is relatively soft, it is possible to suppress the white key 2a from being pushed into the aftertouch performance region. Therefore, key-pressing intended for normal performance can be suppressed from being detected as aftertouch.

Meanwhile, as shown in FIG. 9B, at the time when the rigid layer 121 is strongly pushed during aftertouch performance, the white key 2a can be significantly displaced due to the deformation of the relatively soft first cushion layer 120. Therefore, aftertouch can be detected with high accuracy. In other words, normal performance and aftertouch can be accurately distinguished and detected.

Furthermore, even if the key-pressing stopper 12 is strongly pushed by the pair of side plates 21, the rigid layer 121 deforms to bend, so the load due to the pushing is distributed by the rigid layer 121. That is, the rigid layer 121 can regulate the deformation of the pair of side plates 21 in a way that prevents them from digging into the first cushion layer 120, thereby improving the durability of the key-pressing stopper 12 (making the first cushion layer 120 less likely to become compressed).

Additionally, the key-pressing stopper 12 is formed in a linear shape extending in the scale direction (arrow L-R direction), and the swinging of multiple keys 2 (for example, the keys 2 for one octave) arranged in the scale direction is regulated by one key-pressing stopper 12. As a result, even if the key-pressing stopper 12 is strongly pushed in by the pair of side plates 21, the pushing force can be effectively distributed by the bending of the rigid layer 121 extending in the scale direction. Therefore, the durability of the key-pressing stopper 12 can be improved.

By improving the durability of the key-pressing stopper 12, it is possible to suppress the reduction of the thickness of the key-pressing stopper 12 over time, thereby suppressing the gradual deepening of the terminal position of normal performance. Therefore, key-pressing intended for normal performance can be suppressed from being detected as aftertouch, so normal performance and aftertouch can be accurately distinguished and detected.

As described above, in the embodiment, it is configured that, in addition to aftertouch, the key-pressing information at the time of normal performance until contact with the key-pressing stopper 12 is also detected based on the output value of the coil 100. In other words, since it is configured that normal performance and aftertouch are detected by one sensor, in such a configuration, it is particularly preferable to regulate the displacement of the white key 2a by using the key-pressing stopper 12 including the respective layers 120-122. Accordingly, normal performance and aftertouch can be accurately distinguished.

However, even in a keyboard device where the sensor (keyboard switch 4) for detecting key-pressing information during normal performance and the sensor (pressure sensor 5) for detecting aftertouch are separate sensors, as in the conventional technique (e.g., Japanese Patent Application Laid-Open Publication No. H08-234751), the swinging of the keys may also be regulated by using the key-pressing stopper 12 of the embodiment.

Here, in the case where the purpose is simply to impart a full stroke feel for normal performance by using the rigid layer 121 alone while allowing a large displacement of the white key 2a through the deformation of the first cushion layer 120 during aftertouch performance, it is possible to omit the second cushion layer 122. However, when the white key 2a comes into contact with the relatively rigid (for example, made of PET) rigid layer 121, noise due to this contact is likely to occur.

Therefore, as in the embodiment, the second cushion layer 122, which is softer than the rigid layer 121, may be laminated on the surface layer side of the rigid layer 121. Accordingly, the impact when the pair of side plates 21 come into contact with the key-pressing stopper 12 can be absorbed by using the second cushion layer 122. Therefore, the noise generated at the time of the contact can be reduced.

On the other hand, the first cushion layer 120 is softer than the second cushion layer 122. Accordingly, it is possible to reduce the noise generated at the time when the white key 2a (side plate 21) comes into contact with the key-pressing stopper 12 by using the second cushion layer 122, while the white key 2a can be significantly displaced through the deformation of the first cushion layer 120 during the aftertouch performance.

The thickness of the first cushion layer 120 is between 1.5 mm or more and 8.0 mm or less, and the thickness of the rigid layer 121 is between 0.1 mm or more and 0.5 mm or less. Additionally, the thickness of the second cushion layer 122 is 1.0 mm or more and 3.0 mm or less.

That is, since the thickness of the rigid layer 121 is less than the thickness of the first cushion layer 120, it is possible to impart the full stroke feel for normal performance by using the rigid layer 121, whereas the white key 2a can be significantly displaced through the deformation of the first cushion layer 120 during aftertouch performance.

Furthermore, the thickness of the second cushion layer 122 is greater than the thickness of the rigid layer 121 and less than the thickness of the first cushion layer 120. Accordingly, when the full stroke feel for normal performance is imparted by using the rigid layer 121, it is possible to reduce the noise at the time when the white key 2a (the side plate 21) and the second cushion layer 122 come into contact, whereas the white key 2a can be significantly displaced through the deformation of the first cushion layer 120 at the time of aftertouch performance.

A stopper part 28 is integrally formed on the side plate 21 of the white key 2a to regulate the swinging of the white key 2a at the time of key release. The stopper part 28 extends downward from the side plate 21, and a bending part 28a that bends toward the rear side (the front side in the direction perpendicular to the paper surface in FIG. 9) is formed at the lower end of the stopper part 28.

The bending part 28a is hooked onto the lower surface of the support part 41 through a through hole 46 formed in the front leg part 40 of the chassis 4 (see FIG. 5), and a key-releasing stopper 13 facing the bending part 28a in the upper-lower direction is adhered to the lower surface of the support part 41 of the chassis 4.

In the key-releasing stopper 13, a first cushion layer 130, a rigid layer 131, and a second cushion layer 132 are laminated in this order from the side of the support part 41 of the chassis 4. The respective layers 130 to 132 have the same configuration as the respective layers 120 to 122 of the key-pressing stopper 12.

Therefore, although not illustrated, even when the key-releasing stopper 13 is pushed in

by the bending parts 28a of the pair of stopper parts 28 during the key-release of the white key 2a, the rigid layer 131 that is relatively rigid causes the first cushion layer 130 to be compressed as a whole (the pushing force of the white key 2a is distributed by the rigid layer 131), so the pressure applied to the first cushion layer 130 can be reduced. In other words, since the rigid layer 131 can regulate the deformation of the pair of bending parts 28a from digging into the first cushion layer 130, the durability of the key-releasing stopper 13 can be improved.

Furthermore, the key-releasing stopper 13 is formed in a linear shape extending in the scale direction, and the swinging of multiple keys 2 (for example, keys 2 for one octave) arranged in the scale direction at the time of key release is regulated by one key-releasing stopper 13. Accordingly, the pushing force by the pair of bending parts 28a can be effectively distributed by the deflection of the rigid layer 131 extending in the scale direction. Therefore, the durability of the key-releasing stopper 13 can be improved.

By improving the durability of the key-releasing stopper 13, the gradual thickness reduction of the key-releasing stopper 13 over time can be suppressed. Therefore, the gradual increase in the height of the white key 2a at the initial position before key-pressing can be suppressed. Consequently, it is possible to suppress the occurrence of height variation among the respective keys 2 placed in the initial position, so the appearance of the keyboard device 1 can be improved.

Furthermore, by maintaining the height of the white key 2a at the initial position before key-pressing to be constant, it is possible to suppress the deviation of the engagement position between the guide pin 73 (see the enlarged portion in FIG. 1) and the groove 80 from the design value. Consequently, the key-pressing information of the white key 2a can be accurately detected based on the displacement of the displacement member 8 (change in sensor output value).

In this way, by regulating the swinging of the white key 2a with each stopper 12, 13 having a laminated structure, the initial position of the white key 2a before key-pressing or the terminal position of normal performance becomes less likely to change over time. However, it is difficult to completely eliminate the change (that is, aging) in the initial position or the terminal position of the white key 2a over time.

Comparatively, in the embodiment, the sensor output values at the respective positions of the initial position of the white key 2a before key-pressing, the terminal position of normal performance, and the terminal position of aftertouch are corrected (calibrated), and the key-pressing information for normal performance and aftertouch is then detected based on the correction values.

Specifically, regarding the initial position before key-pressing, in the case where it can be determined through changes of the sensor output value over time that the height of the white key 2a (sensor output value) is higher than the first threshold and the white key 2a is static, the height of the white key 2a (sensor output value) is corrected to be determined as the initial position before key-pressing. An example of the case where it is possible to determine from the changes of the sensor output value over time that the white key 2a is static is when the white key 2a has continued in a static state for a certain period of time.

In addition, regarding the initial position of normal performance, the acceleration (deceleration) upward generated at the time when the white key 2a contacts the key-pressing stopper 12 is detected from the changes of the sensor output value over time, and correction is made so that the position of the white key 2a where the upward acceleration is generated (the sensor output value at such position) is determined as the terminal position of normal performance.

In addition, regarding the initial position of aftertouch, correction is made so that the position of the white key 2a at the time when the height of the white key 2a (sensor output value) is the lowest is determined as the terminal position of aftertouch.

By performing such correction, normal performance and aftertouch cannot be distinguished. In addition, the correction of the sensor output value for each position may be made automatically during the performance of the performer, and may also be made at the time when the performer starts a mode that performs correction.

Furthermore, although the correction (calibration) of the sensor output values at the respective positions of the white key 2a described above describes a correction method for the case where the sensor output value decreases at the time of key-pressing (as the stroke length of the white key 2a increases), it is possible to make a similar correction in the case where the sensor output value increases as the time of key-pressing. For example, in the case where the sensor output value increases at the time of key-pressing, it suffices as long as correction is made to determine that the sensor output value is at the initial position before key-pressing if it can be determined from the changes of the sensor output value over time that the sensor output value is lower than the first threshold. Additionally, it suffices as long as the correction is made to determine that the value when the sensor output value becomes the highest is the terminal position of aftertouch.

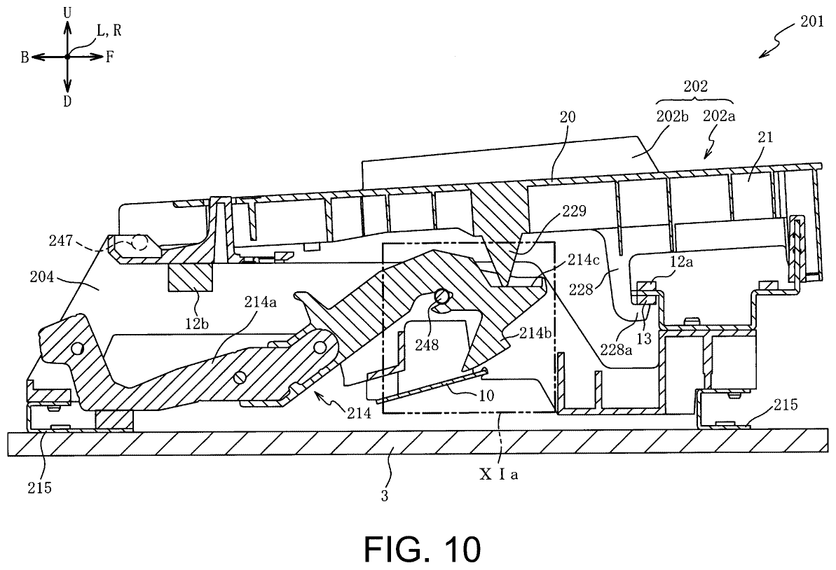

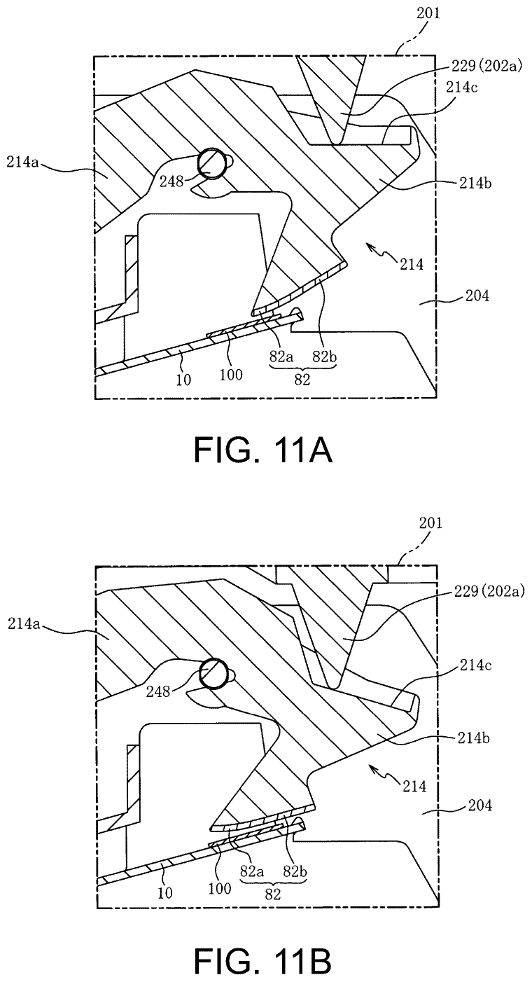

Next, referring to FIG. 10 and FIG. 11, a keyboard device 201 of the second embodiment will be described. In the first embodiment, the case where the detected part 82 is formed on the displacement member 8 linked to the white key 2a is described. However, in the second embodiment, a case where the detected unit 82 is formed on a hammer 214 linked to the white key 202a will be described. It should be noted that the same reference numerals are assigned to the same parts as in the first embodiment described above, and their explanations are omitted.

FIG. 10 is a cross-sectional view of the keyboard device 201 in the second embodiment. FIG. 11A is a partially enlarged cross-sectional view of the keyboard device 201 showing an enlarged view of an XIa portion in FIG. 10, and FIG. 11B is a partially enlarged cross-sectional view of the keyboard device 201 showing the state where the white key 202a is pressed from the state in FIG. 11A to the terminal position of aftertouch.

As shown in FIG. 10, the keyboard device 201 includes multiple (in this embodiment, 88) keys 202, and is a device that forms a keyboard instrument (electronic piano). The keys 202 are formed by white keys 202a and black keys 202b, and the white keys 202a and black keys 202b are arranged in the scale direction (arrow L-R direction).

On the upper surface of the base plate 3, a resin chassis 204 is supported via a channel material 215. On the upper surface of the rear end side (the end on the arrow B side) of the chassis 204, a rotation shaft 247 of the key 202 is provided, and the rear end portion of each key 202 is pivotally supported by the rotation shaft 247.

In the substantially central portion of the chassis 204 in the front-rear direction (arrow F-B direction), the hammer 214 is rotatably supported around a rotation shaft 248 extending along the scale direction. The hammer 214 includes a mass part 214a (mass body) for providing a key-pressing feel during the pressing of the white key 2a, and the mass part 214a is positioned on the rear side (arrow B side) with respect to the rotation shaft 248.

The portion of the hammer 214 on the front side (arrow F side) with respect to the rotation shaft 248 is configured as a facing part 214b that faces the substrate 10 when the white key 202a is pressed. On the upper surface of the facing part 214b, a receiving part 214c that is concave downward is formed, and a protrusion part 229 of the white key 2a is inserted into the receiving part 214c.

The protrusion part 229 protrudes downward from the lower surface of the substantially central portion of the upper plate 20 of the white key 202a in the front-rear direction. The bottom surface of the receiving part 214c is configured as a slide surface on which the tip (lower end) of the protrusion part 229 slides in the front-rear direction.

As shown in FIG. 11, when the white key 202a is pressed, the protrusion part 229 slides along the bottom surface of the receiving part 214c of the hammer 214, while the facing part 214b is pushed downward by the protrusion part 229, thereby rotating the hammer 214 about the rotation shaft 248 (clockwise in FIG. 11). Through the rotation of the hammer 214, the facing part 214b of the hammer 214 is displaced with respect to the substrate 10. In the following description, the outer surface of the hammer 214 that faces toward a direction perpendicular to the axial direction (scale direction) of the rotation shaft 248 will be referred to as the “outer peripheral surface”.

On the outer peripheral surface of the facing part 214b of the hammer 214, the detected part 82 similar to that of the first embodiment is formed by adhering a plate of a non-magnetic metal (such as copper) or through plating.

As the stroke length of the white key 202a increases from the initial position before key-pressing, the penetration amount of the detected part 82 into the detection region increases. Meanwhile, in the case where the white key 202a is released after being pressed, the hammer 214 rotates (counterclockwise in FIG. 11) to return to the initial position due to the weight of the mass part 214a. Through the rotation of the hammer 214, the penetration amount of the detected part 82 into the detection region decreases. As a result, the inductance (sensor output value) of the coil 100 changes, and based on the change, the key-pressing information is detected.

In the detected part 82, a curved surface part 82a positioned on the front side in the rotation direction of the hammer 214 at the time of key-pressing and a plane part 82b connected to the rear side of the curved surface part 82a in the same rotation direction are formed. The curved surface part 82a is formed in a convex curved shape in a direction away from the rotation shaft 248 of the hammer 214, and the plane part 82b is formed as a plane extending in the tangential direction of the rear end (the end on the arrow F side) of the curved surface part 82a.

In this way, in the embodiment as well, since the curvature of the plane part 82b is smaller than the curvature of the curved surface part 82a of the detected part 82, the distance between the coil 100 and the detected part 82 (plane part 82b) in the performance region of the aftertouch can be reduced. Accordingly, the dynamic range can be expanded, and therefore the sensor output value in the performance region of the aftertouch can be significantly reduced.

As shown in FIG. 10, when the white key 202a is pressed, the swinging of the white key 202a is regulated by the key-pressing stopper 12a that contacts the lower surface of the white key 202a and the key-pressing stopper 12b that contacts the mass part 214a of the hammer 214.

While not shown in the drawings, in each of the stoppers 12a and 12b, layers 120 to 122 (see FIG. 9) are laminated like the key-pressing stopper 12 of the first embodiment. Accordingly, during normal performance, a relatively firm full-stroke feel is imparted by the rigid layer 121 (see FIG. 9), while during aftertouch performance, the white key 202a can be significantly displaced due to the deformation of the first cushion layer 120. As a result, normal performance and aftertouch can be accurately distinguished and detected.

Additionally, a stopper part 228 extends downward from the side plate 21 of the white key 202a, and a bending part 228a bends toward the front side (arrow F side) from the lower end of the stopper part 228. The swinging of the white key 202a at the time of key release is regulated by the key-releasing stopper 13, which is attached to the chassis 204, contacting the bending part 228a.

Although not shown in the drawings, in the key-releasing stopper 13 as well, the layers 130 to 132 (see FIG. 9) are laminated like the key-releasing stopper 13 of the first embodiment mentioned above. Therefore, at the time of releasing the white key 202a, the rigid layer 131 can regulate the bending part 228a from deforming to bite into the first cushion layer 130. Therefore, the durability of the key-releasing stopper 13 can be improved.

The invention has been described based on the embodiments, but it is not limited to these embodiments. It can be easily inferred that various improvements and modifications are possible within the scope of the invention without departing from the spirit of the invention.

In the embodiments, the case where normal performance and aftertouch are detected based on the output value of the coil 100 have been described, but the invention is not necessarily limited thereto. For example, separate sensors for detecting normal performance and aftertouch may be provided, or a configuration that does not detect aftertouch may also be used.

In the embodiments, a non-magnetic metal (such as copper) is exemplified as an example of the material of the detected part 82 that changes the magnetic field of the coil 100. However, the material of the detected part 82 may be a magnetic metal or a non-metallic material as long as the material is conductive. Examples of the non-metallic material includes conductive polymers (conductive rubber or conductive resin), carbon, and graphite. In other words, the material of the detected part 82 82 is not limited as long as it has the property of generating eddy currents in response to changes in the magnetic field.

In the embodiments, the coil 100 is exemplified as an example of the sensor for detecting key-pressing information (normal performance and aftertouch) of the white key 2a, 202a, but the invention is not necessarily limited thereto. For example, a sensor that detects key-pressing information based on changes in electrostatic capacity may be used, or key-pressing information may be detected using other conventional non-contact sensors (e.g., the sensor described in Japanese Patent Application Laid-Open Publication No. H03-048295) or contact sensors (for example, the pressure sensor described in Japanese Patent Application Laid-Open Publication No. H08-234751).

In the embodiments, the case where the detection unit 82 is formed on the displacement member 8 or the hammer 214 that rotates in conjunction with the swinging of the key 2, 202 is described, but the invention is not necessarily limited thereto. For example, the detection unit 82 may be formed on a displacement member that linearly displaces in conjunction with the swinging of the key 2, 202. An example of such a linearly displacing displacement member is the displacement member 307 described in FIGS. 15 and 16 of PCT/JP2022/032673.

In the embodiments, the case where the detected part 82 is formed by the curved surface part 82a formed in an arc shape (curved shape convex in the direction away from the rotation shaft 90, 248) centered on the rotation shaft 90, 248, and the plane part 82b that is planar and extends in the tangential direction from the rear end of the curved surface part 82a has been described, but the invention is not necessarily limited thereto. For example, the curved surface part 82a may be omitted and the entire detected part 82 may be formed in a planar shape, or the plane part 82b may be omitted and the detected part 82 may be formed in one arc shape. Also, the plane part 82b may be a curved surface with a smaller curvature than the curved surface part 82a.

In the embodiments, the case where the plane part 82b and the coil 100 (substrate 10) face and are substantially parallel to each other in the performance region of aftertouch (terminal position) have been described. However, in the same region (terminal position of key-pressing), the plane part 82b and the coil 100 (substrate 10) may be not parallel to each other.

In the embodiments, the case where the key-pressing stopper 12, 12a contacts the lower surface of the white key 2a, 202a, or where the key-pressing stopper 12b contacts the hammer 214 has been described. However, the arrangement of the key-pressing stopper 12, 12a, 12b can be set as appropriate. Therefore, for example, the displacement of the white key 2a, 202a may also be regulated by making the key-pressing stopper 12, 12a contact the lower surface of the stopper part 28, 228 (bending part 28a, 228a).

In the embodiments, the case where the displacement of the white key 2a, 202a at the time of key-pressing is regulated by the key-pressing stopper 12 including the first cushion layer 120, the rigid layer 121, and the second cushion layer 122 have been described, but the invention is not necessarily limited thereto. For example, some of the layers 120 to 122 may be omitted, or other layers may be added in addition to the layers 120 to 122. As an example of a configuration of adding another layer, a configuration that adds felt between the first cushion layer 120 and the support part 41 of the chassis 4 is exemplified.

In the embodiments, the case where the first cushion layer 120 is made of foam urethane, the rigid layer 121 is made of PET, and the second cushion layer 122 is made of felt have been described, but the invention is not necessarily limited thereto. Other elastic materials such as rubber, elastomers (synthetic resin), or foam materials using these resins may be used to form the respective layers 120 to 122. In other words, the material of each of the layers 120 to 122 can be changed as appropriate. For example, in accordance with JIS K6253-3:2012, in the case of measuring the hardness of each of the layers 120 to 122 with a durometer type A hardness tester, a configuration where the hardness of the rigid layer 121 (second cushion layer 122) is higher than the first cushion layer 120, or a configuration where the hardness of the second cushion layer 122 is lower than the rigid layer 121 may also be adopted.

In the embodiments, the case where the swinging of the multiple keys 2, 202 (for example, keys 2, 202 for one octave) arranged in the scale direction is regulated by one key-pressing stopper 12, 12a, 12b or a key-releasing stopper 13 have been described, but the invention is not necessarily limited thereto. For example, the key-pressing stopper 12 or the key-releasing stopper 13 may be provided for each key 2, 202.

In the embodiments, the case where the thickness of the rigid layer 121 is less than the thickness of the first cushion layer 120, or where the thickness of the second cushion layer 122 is greater than the rigid layer 121 and less than the first cushion layer 120 has been described, but the invention is not necessarily limited thereto. For example, the thickness of the rigid layer 121 may be thicker than the first cushion layer 120. Also, the thickness of the second cushion layer 122 may be less than the rigid layer 121, or may be greater than the first cushion layer 120.

In the first embodiment, it is described that the substrate 10 is supported by the chassis 4 (indirectly) through the holder 9 by attaching the substrate 10 to the holder 9. However, the invention is not limited thereto. It may also be configured that the substrate 10 is attached to the chassis 4 (the substrate 10 is directly supported by the chassis 4). That is, “the substrate 10 supported by the chassis 4 (support member)” is a concept that covers both that the substrate 10 is indirectly attached to the chassis 4 and the substrate 10 is directly attached to the chassis 4. However, it may also be that the substrate 10 is supported on the base plate 3, and the support position of the substrate 10 can be changed as appropriate.

In the first embodiment, it is described that an end (front end) of the substrate 10 is inserted into the protrusions 96, 97 of the holder 9, while the other end (rear end) of the substrate 10 is screwed to the fixed part 112 of the fixed member 11. However, the invention is not necessarily limited thereto. For example, it may also be that an end of the substrate 10 is screwed to the holder 9, or an end of the substrate 10 is hooked onto an elastic claw formed on the holder 9. Additionally, it may also be that a pair of protrusions similar to the protrusions 96, 97 are formed on the fixed member 11 and the other end of the substrate 10 is inserted into that pair of protrusions, and the other end of the substrate 10 is hooked onto an elastic claw formed on the fixed member 11.

In the first embodiment, it is described that the key shaft member 5, the holder 9, and the fixed member 11 are separate parts. However, it may be also be that some or all of the components are integrally formed.

In the first embodiment, the case where multiple key shaft members 5, holders 9, and fixed members 11 are arranged in the scale direction. However, the invention is not necessarily limited there. For example, it may also be configured that all of the keys 2 arranged in the scale direction are pivotally supported by one key shaft member 5, or a configuration where all of the displacement members 8 arranged in the same direction are pivotally supported by one holder 9. Additionally, it may also be configured that the substrate 10 is supported by one fixed member 11.

In the first embodiment, it is described that the guide pin 73 is formed on the linkage member 7 attached to the white key 2a, while the groove 80 engaged with the guide pin 73 is formed on the displacement member 8. However, it may be also be that a groove is formed in the linkage member 7, while a guide pin engaged with the groove is formed on the displacement member 8. Additionally, it may also be that the linkage member 7 (guide pin 73) is integrally formed with the white key 2a.

In the first embodiment, the case where a part of the holder 9 (wall part 91, attached part 92, and connection part 95) positioned on the displacement trajectory of the displacement member 8 functions as a regulation component that regulates the contact between the detected part 82 (plane part 82b) and the coil 100. However, the invention is not necessarily limited thereto. For example, it may be that a part that regulates the displacement of the displacement member 8 is provided on the chassis 4 (support part 41) or other components supported by that chassis 4. 10

In the first embodiment, it is described that the white key 2a and the holder 9 are assembled on the same chassis 4 (support part 41). However, it may also be that the white key 2a and the holder 9 are assembled on separate components.

What is claimed is:

1. A keyboard device, comprising:
a plurality of keys, arranged in a scale direction; a displacement member, rotating by moving in conjunction with swinging of the key; a detected part, provided on an outer peripheral surface of the displacement member and being conductive; and a coil, facing the detected part and generating a magnetic field,
wherein the detected part is at least formed by a first detected part and a second detected part, the first detected part is in a curved surface shape located on a front side of the displacement member in a rotation direction, and the second detected part is connected to a rear side of the first detected part in the rotation direction and has a curvature smaller than that of the first detected part.

2. The keyboard device as claimed in claim 1, wherein the detected part has a property of being able to generate an eddy current in accordance with a change in the magnetic field.

3. The keyboard device as claimed in claim 1, wherein the detected part is made of metal.

4. The keyboard device as claimed in claim 1, comprising:
a key-pressing stopper, regulating swinging of the key at a time of key-pressing,
after the key contacts the key-pressing stopper, the coil further detects a displacement of the key, as aftertouch, at a time when the key is pushed in.

5. The keyboard device as claimed in claim 1, wherein the second detected part is formed to be planar.

6. The keyboard device as claimed in claim 5, wherein in an aftertouch performance region, the second detected part and the coil face each other to be substantially parallel.

7. The keyboard device as claimed in claim 5, wherein at an initial position before key-pressing, the first detected part and the coil face each other.

8. The keyboard device as claimed in claim 1, wherein one of the key and the displacement member comprises a guide pin protruding in the scale direction, and an other of the key and the displacement member comprises a groove into which the guide pin is slidably inserted, and
the keyboard device comprises a regulation member regulating contact between the second detected part and the coil by regulating a displacement of the displacement member in a case where the guide pin is removed from the groove.

9. A keyboard device, comprising:
a plurality of keys, arranged in a scale direction; a displacement member, rotating by moving in conjunction with swinging of the key; a detected part, provided on an outer peripheral surface of the displacement member and being conductive; and a coil, facing the detected part and generating a magnetic field,
wherein the detected part comprises at least a plane part, and
through rotation of the displacement member, the plane part is able to face the detected part.

10. The keyboard device as claimed in claim 9, wherein the detected part has a property of being able to generate an eddy current in accordance with a change in the magnetic field.

11. The keyboard device as claimed in claim 9, wherein the detected part is made of metal.

12. The keyboard device as claimed in claim 9, comprising:
a key-pressing stopper, regulating swinging of the key at a time of key-pressing,
after the key contacts the key-pressing stopper, the coil further detects a displacement of the key, as aftertouch, at a time when the key is pushed in.

13. The keyboard device as claimed in claim 9, wherein the plane part of the detected part is formed to be planar.

14. The keyboard device as claimed in claim 13, wherein in an aftertouch performance region, the plane part and the coil face each other to be substantially parallel.

15. The keyboard device as claimed in claim 13, wherein the detected part comprises a curved surface part located on a front side of the displacement member in a rotation direction, and
at an initial position before key-pressing, the curved surface part and the coil face each other.

16. The keyboard device as claimed in claim 15, wherein the curved surface part of the detected part is formed in a curved surface shape.

17. The keyboard device as claimed in claim 1, wherein one of the key and the displacement member comprises a guide pin protruding in the scale direction, and an other of the key and the displacement member comprises a groove into which the guide pin is slidably inserted, and
the keyboard device comprises a regulation member regulating contact between the curved surface part and the coil by regulating a displacement of the displacement member in a case where the guide pin is removed from the groove.

18. A method for detecting key-pressing information of a key in a keyboard device, the keyboard device comprising: a plurality of the keys arranged in a scale direction; a displacement member, rotating by moving in conjunction with swinging of the key; a detected part, provided on an outer peripheral surface of the displacement member and being conductive; and a coil, facing the detected part and generating a magnetic field, and the method comprising:
detecting the key-pressing information of the key by relatively displacing the detected part with respect to the coil, the detected part being at least formed by a first detected part and a second detected part, wherein the first detected part is in a curved surface shape located on a front side of the displacement member in a rotation direction, and the second detected part is connected to a rear side of the first detected part in the rotation direction and has a curvature smaller than that of the first detected part.

19. The method for detecting key-pressing information as claimed in claim 18, wherein the detected part has a property of being able to generate an eddy current in accordance with a change in the magnetic field.

20. The method for detecting key-pressing information as claimed in claim 18, wherein the detected part is made of metal.
